(19) United States
(12) Patent Application Publication
(10) Pub. No.: US 2010/0002983 A1
(43) Pub. Date: Jan. 7, 2010

(54) DISTRIBUTED OPTICAL FIBER DETECTION SYSTEM

(75) Inventors: Victor Il'ich Kopp, Fair Lawn, NJ (US); Jonathan Singer, New Hope, PA (US); Daniel Neugroschl, Suffern, NY (US)

Correspondence Address: EDWARD ETKIN, ESQ., Law Office of Edward Etkin, PC, 228 West End Avenue, Suite A, Brooklyn, NY, 11235, US

(73) Assignee: CHIRAL PHOTONICS, INC., Pine Brook, NJ (US)

(21) Appl. No.: 12/495,772

(22) Filed: Jun. 30, 2009

Related U.S. Application Data
(60) Provisional application No. 61/077,331, filed on Jul. 1, 2008.

(51) Int. Cl. G02B 6/00

(52) U.S. Cl. 385/13; 385/12

(57) ABSTRACT

A distributed elongated optical fiber detection system is provided, having at least one sensitive region, and being capable of detecting the occurrence and location(s) of one or more events along its length that cause one or more perturbations in the at least one sensitive region. In one embodiment of the invention, the novel detection system includes, at its first end, an optical signal source capable of launching a signal in a first signal mode through an optical fiber waveguide comprising at least one sensitive region along its length, and configured for transmitting at least two signal modes therethrough, toward its second end. A reflecting device, capable of reflecting only signals in a second signal mode, is positioned at the second end of the waveguide. An occurrence of at least one event in at least one sensitive region causes a perturbation in the waveguide sufficient to couple at least a portion of the energy of the forward traveling signal into a second signal mode, such that the signal in the second signal mode is reflected back toward the first end of the waveguide. A detector, capable of detecting at least one characteristic of a reflected signal in the second signal mode, is connected to the first end of the waveguide, such that when the at least one event occurs, and a reflected signal in the second signal mode is produced, the detector is capable of determining the quantity of one or more occurring events as well as a location of each of the events along the waveguide lengths. In another inventive embodiment, instead of a reflector, the detector is connected to the second end and detects the signal in the second mode directly.

### CROSS REFERENCE TO RELATED APPLICATIONS

The present patent application claims priority from the commonly assigned co-pending U.S. provisional patent application 61/077,331 entitled “Distributed Optical Fiber Detection System”, filed Jul. 1, 2008.

### FIELD OF THE INVENTION

The present invention relates generally to a detection system with an elongated detection portion that is capable of detecting a predetermined event, occurring proximately thereto, and more particularly to optical fiber detection systems with sensitive portions that include optical fiber waveguides, and that are capable of detecting the occurrence of one or more events proximal to at least one of its sensitive potions as well as the location(s) thereof.

### BACKGROUND OF THE INVENTION

There are many thousands of miles of pipelines scattered throughout the world for transporting petroleum, natural gas, and similar valuable (and volatile) resources between different geographic locations. Most often pipelines are constructed in “runs” of many miles between pumping stations that ensure that the transported resources flow through the pipeline at an appropriate speed and under predetermined pressure. Many pumping stations also have another purpose—to monitor the pressure in the connected pipeline runs, so that if a pipeline run is breached (accidentally or maliciously) sufficiently to cause at least a portion of the transported resource to escape the pipeline, the pumping stations can detect the drop in pressure and alert human operators that their urgent intervention is needed. More advanced safety systems may also initiate certain emergency protocols such as shutting off the affected run, and, if applicable, possibly diverting the transported resource to another pipeline run.

However, this method of “problem” or “event” detection is very flawed in that a drop in transported resource pressure over a particular pipeline run only indicates that there is a breach somewhere along the run, but does not provide any information about the location thereof. In most cases, the vast majority of the pipeline runs are located in very remote and often difficult to access areas (and even underground in many cases), with each run between pumping stations being many miles. As a result, when a pipeline breach occurs, a great deal of resources must be expended by the pipeline operators to locate the exact position of the breach. Traditionally, such efforts involved transporting one or more qualified teams to the are of the affected pipeline run to conduct visual inspection of the run from the ground or from the air—a very expensive and time consuming task. In cases where at least part of the affected run is buried underground or submerged under water, locating the position of the breach became even more problematic.

To address the above problem, a number of solutions were developed for the purpose of assisting the pipeline operators in locating the actual position of a breach along selected pipeline runs. The most popular and successful approach involved the use of a breach detection system, installed for each selected pipeline run, which utilized an elongated “detecting” component, installed proximal to, and along the pipe, in form of an optical fiber or of a pair of electrical wires, connected to an optical time domain reflectometer (OTDR), when the detecting component is an optical fiber, or to an electrical time domain reflectometer (ETDR) when the detecting component is an electrical wire pair. Because both previously known OTDR and ETDR based detection systems (hereinafter collectively referred to as “TDR systems”) are based on similar core principles, it should be understood that for the sake of convenience, it is sufficient to describe an exemplary embodiment of a previously known OTDR-based reflection system by way of example, with the understanding that previously known ETDR-based detection systems operate in an analogous manner (e.g., an ETDR is used instead of the OTDR, the wire pair is used instead of an optical fiber as the detection component, and an electrical signal is sent and monitored rather than a light signal).

Referring now to FIGS. 7A and 7B, an exemplary commonly utilized previously known OTDR-based pipeline breakage detection system 500, configured for use with a pipeline run 550 is shown. The previously known detection system 500 includes an elongated optical fiber 502 of a length L-a with a first end 504a connected to an OTDR 506, and an opposite second end 504b. The optical fiber 502 is positioned along, and in longitudinal contact (or at least in close proximity) with the pipeline run 550. In normal operation of the system 500 shown in FIG. 7A, the OTDR 506 sends a light signal 508 through the connected optical fiber 502 from the first end 504a toward the second end 504b thereof operable not to reflect the signal 508. As long as the OTDR 506 is not detecting a reflection of the signal 508, the system 500 reports that the pipeline run 550 does not have a significant breakage.

However, as shown in FIG. 7B, when a breakage 552 in the pipeline run 550 occurs that is sufficient to cause a corresponding proximal breakage 510 in the optical fiber 502, a length L-b away from the first end 504a, the signal 508 originating from the OTDR 506, is reflected at the breakage 510 in a direction substantially back toward the OTDR 506 as a reflected signal 512.

Detection, by the OTDR 506, of the reflected signal 512 arriving from the first fiber end 504a, indicates that a breakage in the fiber 502, and thus likely a breakage in the pipeline run 550 has occurred. Utilizing its time-domain computational features, because the length L-a of the optical fiber 502, the speeds of propagation of the signals 508 and 512 in the fiber 502, and the time taken for the signal 512 to arrive at the OTDR 506 are all known, the OTDR 506 can readily determine the distance L-b of the optical fiber breakage 510 (and correspondingly of the pipeline run breakage 552) from the first optical fiber end 504a.

While the above-described previously known TDR-based detection system solutions have their utility in certain situations, for example where a portion of a pipeline run is significantly damaged or destroyed, they suffer from a number of significant disadvantages. First, and most important, the majority of incidents involving transportation of resources such as petroleum or natural gas, are leaks that result from relatively small cracks or holes in the pipeline, rather than explosions or breakages sufficient to break the detecting component (optical fiber or wire pair). Thus, while previously known pressure monitoring systems can determine that one or more resource leaks have occurred in a pipeline run between two pumping stations, the conventional TDR-based detection systems cannot detect the location of any leak events other than ones that result in significant disruption of the detecting component (optical fiber or wire pair). As a result, because they are only able to detect the relatively rare disastrous pipeline incidents, and have no ability to detect the much more prevalent leak events that would not significantly damage their detection components, the previously known TDR-based detection systems meet only a small portion of the significant need of the resource transportation and pipeline construction operation, and management industries to detect the presence and location of all resource leaks along monitored pipeline runs, especially the more prevalent leaks that result from relatively small disruptions in the pipeline.

Furthermore, by its very nature, a typical conventional TDR-based detection system is capable of only detecting a single disruptive event along its detection component length. Moreover, conventional TDR-based systems cannot detect any events which involve the presence of undesirable material in proximity to, or in contact with, its detection component (such as may occur from a slow resource leak from a pipeline). Finally, most previously known TDR-based detection systems have no ability to detect changes in temperature proximal to their respective detection components, unless such changes involve a rise in temperature sufficient to significantly disrupt the detection components. Thus, a fire proximal to a pipeline run that is sufficiently hot and aggressive to significantly raise the temperature of the affected pipeline run section would not be detected by any conventional TDR-based detection system until the fire resulted in an explosion—i.e., a detection would only occur after the damage has been done, rather than in time to prevent a highly undesirable incident.

It would thus be desirable to provide an optical fiber detection system having at least one elongated detection portion capable of detecting a presence, and relative position of, one or more predetermined events occurring proximately thereto, and affecting at least one portion thereof, even if one or more of such events cause only a slight perturbation of the at least one detection portion. It would also be desirable to provide an optical fiber detection system having at least one elongated detection portion capable of detecting a presence, and relative position of one or more events, at least one of which comprises pressure exerted on the at least one elongated detection portion. It would further be desirable to provide an optical fiber detection system having at least one elongated detection portion capable of detecting a presence, and relative position of one or more events, at least one of which comprises a change in temperature proximal thereto, that is outside a predefined temperature range. It would additionally be desirable to provide an optical fiber detection system having at least one elongated detection portion capable of detecting a presence and position of one or more events, at least one of which comprises a presence of at least one predetermined material proximal to, or in contact with, the detection portion.

### BRIEF DESCRIPTION OF THE DRAWINGS

In the drawings, wherein like reference characters denote corresponding or similar elements throughout the various figures:

FIG. 1 is a schematic diagram of a side view of a first exemplary embodiment of the distributed optical fiber detection system of the present invention;

FIG. 2A is a schematic diagram of a first exemplary embodiment of signal source/detector component of the distributed optical fiber detection system of FIG. 1, in which the signal source/detector component is provided and configured as a single unit;

FIG. 2B is a schematic diagram of a second exemplary embodiment of a signal source/detector component of the distributed optical fiber detection system of FIG. 1, in which the signal source and detector are provided and configured as separate components;

FIG. 3 is a schematic diagram of a side view of a second exemplary embodiment of the distributed optical fiber detection system of the present invention;

FIG. 4 is a schematic diagram of a side view of a third exemplary embodiment of the distributed optical fiber detection system of the present invention;

FIG. 5 is a schematic diagram of a side view of a first alternate exemplary embodiment of the inventive distributed optical fiber detection system of FIG. 1 or 3;

FIG. 6 is a schematic diagram of a side view of a second alternate exemplary embodiment of the inventive distributed optical fiber detection system of FIG. 1 or 3, shown by way of example in exemplary utilization thereof; and

FIGS. 7A and 7B are schematic diagrams of an exemplary prior art optical or electrical waveguide disruption detection system.

### SUMMARY OF THE INVENTION

The present invention is directed to a distributed elongated optical fiber detection system having at least one sensitive region, and being capable of detecting the occurrence and location(s) of one or more events along its length that cause one or more perturbations in the at least one sensitive region.

In one embodiment of the present invention, the novel detection system includes, at its first end, an optical signal source capable of launching a signal in a first signal mode through an optical fiber waveguide comprising at least one sensitive region along its length, and configured for transmitting at least two signal modes therethrough, toward its second end. A reflecting device, capable of reflecting only signals in a second signal mode, is positioned at the second end of the waveguide. An occurrence of at least one event in at least one sensitive region causes a perturbation in the waveguide sufficient to couple at least a portion of the energy of the forward traveling signal into a second signal mode, such that the signal in the second signal mode is reflected back toward the first end of the waveguide. A detector, capable of detecting at least one characteristic of a reflected signal in the second signal mode, is connected to the first end of the waveguide, such that when the at least one event occurs, and a reflected signal in the second signal mode is produced, the detector is capable of determining the quantity of one or more occurring events as well as a location of each of the events along the waveguide lengths.

In another inventive embodiment, instead of a reflector, the detector is connected to the second end and detects the signal in the second mode directly.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF THE PREFERRED EMBODIMENTS

The “distributed” optical fiber detection system of the present invention not only addresses the flaws and shortcomings of previously known time domain reflectometry (TDR) detection systems, but is also capable of sensing the number of relative locations of multiple predefined events affecting at least a portion of at least one sensing section thereof, while providing a greatly expanded scope of different sensed event types (such as temperature variations, pressure, and presence of predefined sensed materials).

In summary, the present invention is directed to a distributed elongated optical fiber detection system, having at least one elongated sensitive region, and being capable of detecting the occurrence and location(s) of one or more events along its length, that cause one or more perturbations in the at least one sensitive region thereof. In one embodiment of the invention, the novel optical fiber detection system includes, at its first end, an optical signal source capable of launching a signal in a first signal mode through an optical fiber waveguide comprising at least one sensitive region along its length, and configured for transmitting at least two signal modes therethrough toward its second end. A reflecting device, capable of reflecting only signals in a second signal mode, is positioned at the second end of the waveguide. An occurrence of at least one event in at least one sensitive region sufficient to cause a perturbation in the waveguide, causes a coupling of at least a portion of the energy of the forward traveling signal into a second signal mode, such that the signal in the second signal mode is reflected back toward the first end of the waveguide. A detector, capable of detecting at least one characteristic of a reflected signal in the second signal mode, is connected to the first end of the waveguide, such that when the at least one event occurs, and a reflected signal in the second signal mode is produced, the detector is capable of determining the quantity of one or more occurring events, as well as a location of each such event along the waveguide length. An optional control system connected thereto may be operable to collect, process, and/or interpret the results of the inventive detection system and to transmit the output thereof. In another inventive embodiment, instead of a reflector, the detector is connected to the second end of the waveguide and detects the signal with energy coupled into the second mode directly.

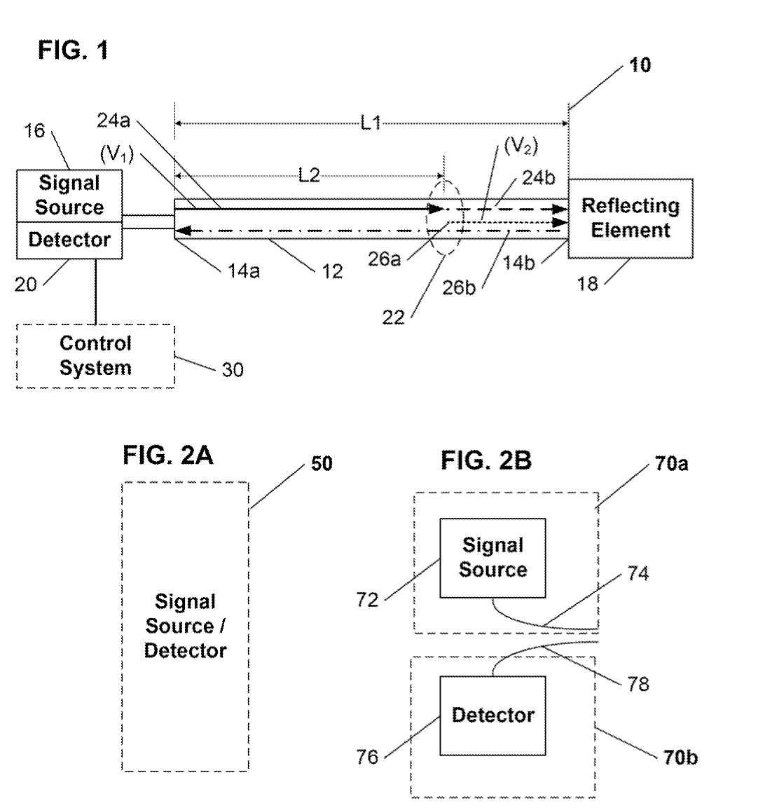

Referring now to FIG. 1, a first embodiment of a distributed optical fiber detection system is shown as a distributed optical fiber detection system 10. The detection system 10 includes an elongated bidirectional optical fiber waveguide 12, comprising a sensitive region along its length L1, between its first end 14a and its second end 14b, described in greater detail below. The fiber waveguide 12 preferably comprises an optical fiber structure capable of bi-directionally guiding therethrough, between its ends 14a and 14b, signals in at least two different electromagnetic signal modes. Accordingly, by way of example, the fiber waveguide 12, may selected, as a matter of design choice and without departing from the spirit of the invention, from a group of optical fiber structures that include, but that are not limited to: multi-mode optical fibers, polarization maintaining optical fibers, or a pair of proximal single mode fibers having different numerical apertures.

A signal source 16, which may be any source of electromagnetic wave signals capable of launching a signal in at least one predetermined signal mode, is connected to the first waveguide end 14a, and is operable to launch a first signal 24a of a first signal mode into the fiber waveguide 12 through the first end 104a (which, by way of example, may be propagating at a velocity V₁).

The sensitive region of the waveguide 12 along the length L1, is preferably configured such that when the first signal 24a is launched into the waveguide first end 14a in a first signal mode, a perturbation 22 affecting a portion of the sensitive region of the waveguide 12 (for example, such as may be caused by an event occurring at least proximally to the sensitive region) causes the waveguide 12 to couple at least a portion of the energy of the first signal mode of the signal 24a into a second signal mode (for example, that is of a different propagation constant from the first signal mode of the signal 24a, and that may, by way of example, be propagating at a velocity V₂), to produce a second signal 26a, while the remaining energy of the signal 24a in the first signal mode, continues in a modified signal 24b toward the second waveguide end 14b.

A reflecting element 18, positioned at the second waveguide end 14b, is preferably capable of reflecting only a signal arriving thereto in a second signal mode (such as the second signal 26a), to produce a reflected signal 24b of the second signal mode that is directed back toward the waveguide first end 14a. A detector 20, positioned at the first waveguide end 14a, is preferably capable of detecting at least one characteristic of the reflected signal 26b in the second signal mode (for example, depending on the type of signal (wave, pulse), signal 26b time delay, amplitude, phase shift, propagation velocity, etc) that preferably enable the detector 20 to determine the occurrence of the perturbation 22 (and thus detect the occurrence of the event responsible for the perturbation 22), as well as to determine the distance L2 of the perturbation 22 from the first waveguide end 14a, using at least one applicable mathematical technique.

In one embodiment of the present invention, the signal source 16 and the detector 20 may be provided and configured as separate components. In an alternate embodiment of the present invention, the necessary functionality of the signal source 16 and the detector 20 may be provided by a single component, such as a signal source/detector 50 of FIG. 2A, which may for example be an optical time domain reflectometer (OTDR). By way of example, an OTDR 50a, providing the functionalities of the signal source 16 and detector 20 of FIG. 1, can utilize its time-domain computational features to determine the distance L2 of the perturbation 22 from the first waveguide end 14a, because the length L1 of the waveguide 12, the speeds of propagation (V₁, V₂) of the signals 24a, and 26a, respectively, and the time delay for the reflected signal 26b arriving at the OTDR 50a are all known.

Referring now to FIG. 2B, in another alternate embodiment of the present invention, the necessary functionality of the source 16 and the detector 20 may be provided and configured as separate independently configurable components—a signal source 72, and a detector 76, each of example may be placed in different physical, or even in a remote, location 70a, 70b, with each component 72, 76 being provided with an appropriate respective connection 74, 78 configured to connect to the first waveguide end 14a.

Returning now to FIG. 1, the nature of the waveguide 12 sensitive region along L1, the type of signals 24a to 26b, as well as the reflecting element 18 and detector 20, and the configuration of their connections to the second waveguide end 14b, and to the first waveguide end 14a, respectively, depend on the specific type and configuration of the waveguide 12. For example, if the waveguide 12 is a polarization maintaining fiber, then:
the signal 24a is of a first predetermined polarization mode,
the waveguide 12 sensitive region along L1 comprises a length of a polarization maintaining fiber that is capable of coupling at least a portion of the energy of the signal 24a into the signal 26a in a second polarization mode in response to perturbation 22 in the sensitive region (e.g., from pressure, temperature change, etc.) of a sufficient magnitude,
the reflecting element 18 comprises a polarizer component (such an in-line chiral fiber polarizer) selected or configured to only pass signals in the second polarization mode (i.e., the signal 26a), and to reject signals in the first polarization mode (such as the remaining first polarization mode signal 24b), followed by a mirror (or equivalent) element that reflects signals in the second polarization mode passed by the polarizer component (i.e., the signal 26a), to thus produce a reflected signal 26b in the second polarization mode traveling toward the detector 20, and
the detector 20 is capable of detecting at least one characteristic of only signals that arrive in the second polarization mode, such as the reflected signal 26b, to derive the necessary information regarding the occurrence and position of the perturbation

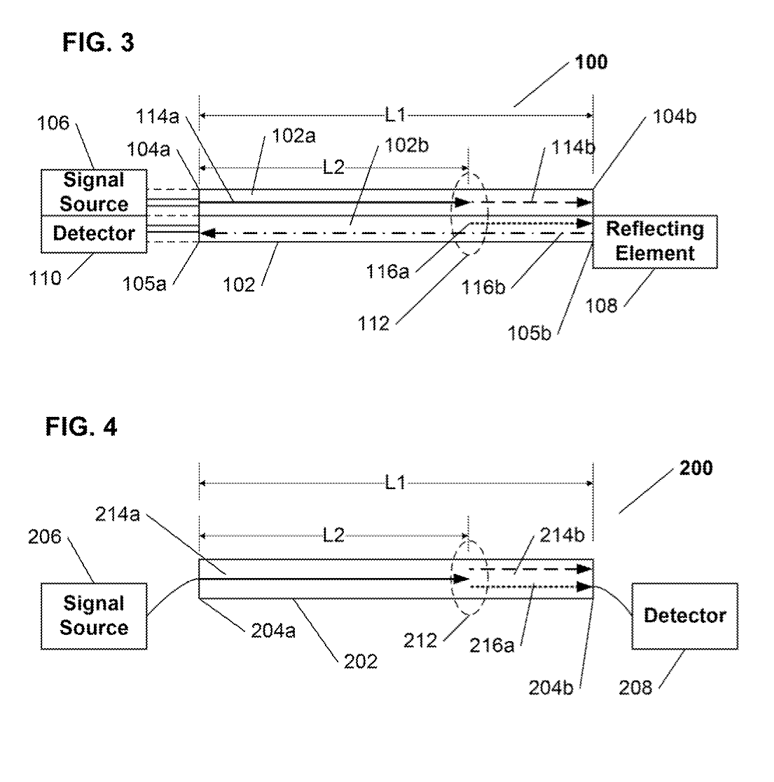

An different embodiment of the inventive detection system, in which the waveguide 12 is a pair of single mode fibers with different numerical apertures is discussed in greater detail below in connection with FIG. 3.

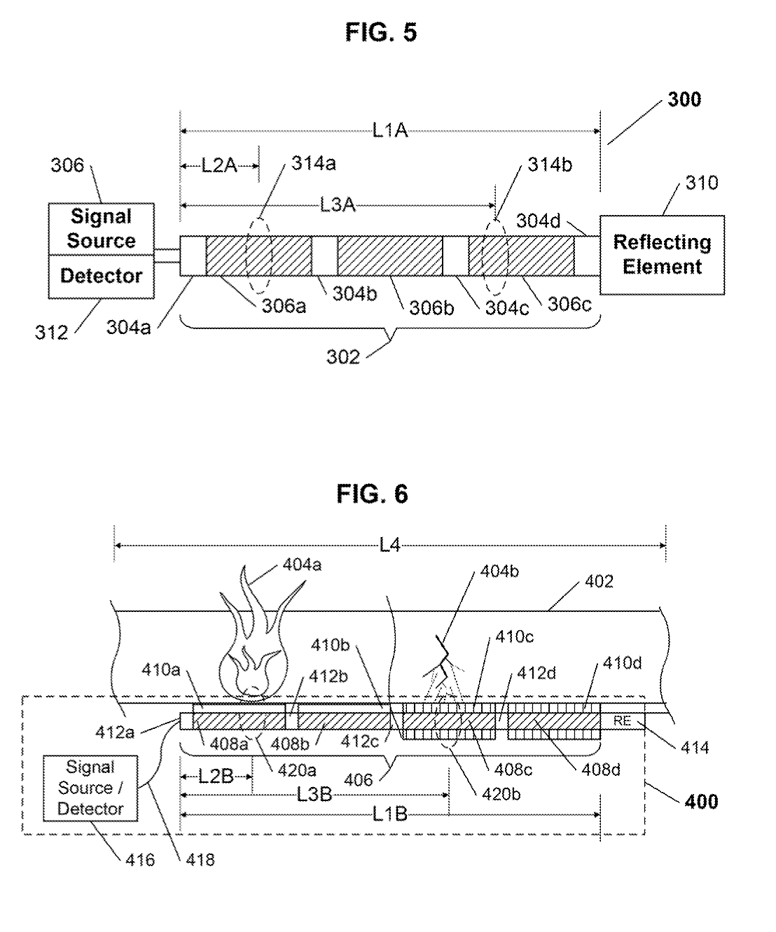

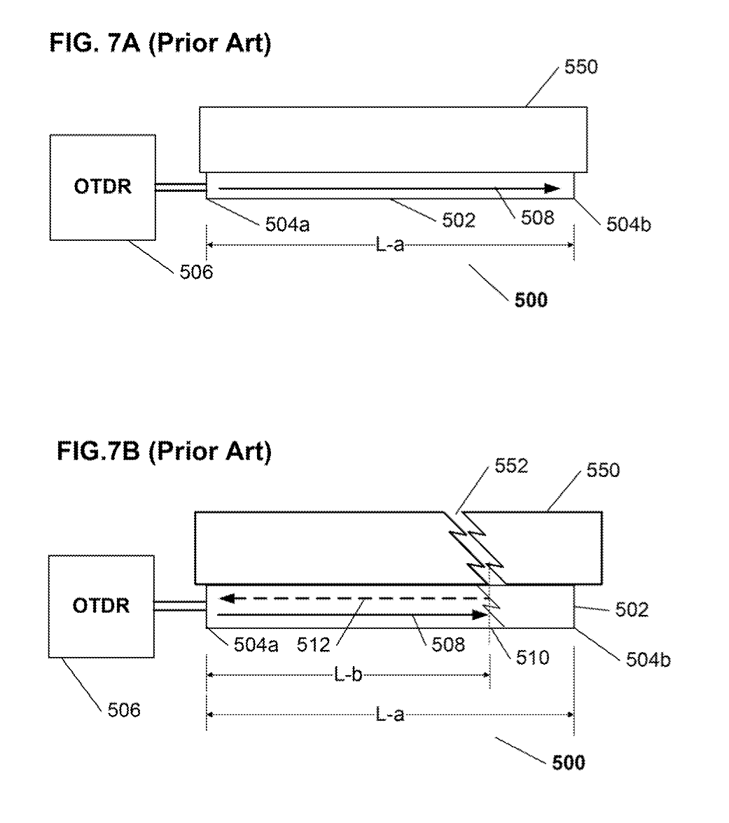

It should be noted that the various embodiments of the inventive optical fiber detection systems 10, 100, and 200 are each shown with the respective waveguides thereof (waveguides 12, 102, and 202, respectively) as having a single corresponding sensitive region disposed along the length thereof. However any waveguide component of the various embodiments of inventive optical fiber detection system may comprise two or more sequential separate sensitive regions (which may in some embodiments thereof be more fragile and/or expensive to produce than the rest of the waveguide) alternating with non-sensitive portions of the waveguide. Multiple embodiments of the inventive detection system with waveguides comprising plural sensing sections, are shown and described further below in connection with FIGS. 5 and 6.

It should also be noted that while only a single perturbation 22 is shown in FIGS. 1, 3 and 4, each embodiment of the inventive detection system is readily capable of detecting the occurrence and positions of multiple perturbations in one or more sensitive region of each corresponding waveguide component thereof, because in accordance with the present invention, any particular perturbation only couples a portion of the energy of the initially launched signal of a first mode to produce the coupled signal in the second mode, so that second and subsequent perturbations simply result in production of additional signals in the second mode, each with at least one different characteristic from one another such that when they eventually arrive at a detector, the detector is able to readily discriminate between them to determine the number of detected perturbations, as well as relative position of each, along the corresponding waveguide length.

It should further be noted, that while certain perturbations 22 may be inflicted, by occurrence of corresponding events, directly on the sensitive region of the waveguide component of the inventive detection system in various embodiments thereof, the inventive detection system may include at least one additional component, proximal to, or in contact with, at least one sensitive region of the waveguide, that is capable of causing a perturbation in at least one sensitive region of the waveguide in response to occurrence of at least one predetermined proximal event. Thus, if the inventive detection system is utilized in connection with an petroleum pipeline to sense leaks therefrom, while the presence of liquid petroleum product proximal to a sensitive region of the inventive waveguide component, would not cause a perturbation thereon, a proximal element that expands and causes pressure on a proximal sensitive waveguide region in response to contact with petroleum, will ensure that even a very small petroleum leak that occurs proximal to the sensitive region of the waveguide component of the inventive detection system, can be readily detected and its position along the waveguide (and thus its location along the petroleum pipeline run), accurately pinpointed by the inventive system's detector component. Exemplary embodiments of the inventive detection system incorporating the above-described variations, features and components, are shown as exemplary detection systems 300, 400 in respective FIGS. 5 and 6, and described further detail below in connection therewith.

Referring now to FIG. 3, a second embodiment of a distributed optical fiber detection system is shown as a distributed optical fiber detection system 100. The detection system 100 includes an elongated bidirectional optical fiber waveguide 102, comprising a sensitive region along its length L1, described in greater detail below. The fiber waveguide 102 preferably comprises a pair of proximal parallel single mode (SM) optical fibers 102a, 102b, each having a different numerical aperture characteristic, where the first SM fiber 102a is capable of bi-directionally guiding therethrough, between its first end 104a and its second end 104b, signals in a first of two different electromagnetic signal modes, while the second SM fiber 102b is capable of bi-directionally guiding therethrough, between its first end 104a and its second end 104b, signals in a second of two different electromagnetic signal modes.

A signal source 106, which may be any source of electromagnetic wave signals capable of launching a signal in at least one predetermined signal mode, is connected to the first SM fiber end 104a, and is operable to launch a first signal 114a of a first signal mode into the first SM fiber 102a through the first SM fiber end 104a (which, by way of example, may be propagating at a velocity V₁).

The sensitive region of the waveguide 102 along the length L1, is preferably configured as first unjacketed region of the first SM fiber 102a of a first diameter D1, and a second unjacketed region of the second SM fiber 102b of a second diameter D2 (which may be equal to D1), with the diameters D1, D2 of the unjacketed portions of the SM fibers 102a, 102b are sufficiently small and the fibers sufficiently proximal to one another, such that when the first signal 114a in the first signal mode is launched into the first fiber end 104a of the first SM fiber 102a, a perturbation 112 (such as the presence of a predetermined sensed material), that affects a portion of the unjacketed regions of the SM fibers 102a, 102b, at least a portion of the energy of the first signal mode of the signal 114a is coupled from the first SM fiber 102a, into the proximal second SM fiber 102b in a second signal mode (for example, that is of a different propagation constant from the first signal mode of the signal 114a, and that may, by way of example, be propagating at a velocity V₂), to produce a second signal 116a traveling in the second SM fiber 102b toward the second SM fiber end 105b thereof, while the remaining energy of the signal 114a in the first signal mode, continues in a modified signal 114b toward the second end 104b of the first SM fiber 102a.

A reflecting element 108, such as a mirror or equivalent device, positioned at the second end 105b of the second SM fiber 102b, is preferably capable of reflecting only a signal arriving thereto in a second signal mode (such as the second signal 116a), to produce a reflected signal 116b of the second signal mode that is directed back toward the first end 105a of the second SM fiber 102b. A detector 110, positioned at the first end 105a of the second SM fiber 102b, is preferably capable of detecting at least one characteristic of the reflected signal 116b in the second signal that preferably enable the detector 110 to determine the occurrence of the perturbation 112 (and thus detect the occurrence of the event responsible for the perturbation 22), as well as to determine the distance L2 of the perturbation 112 from the pair of the first fiber ends 104a, 105a, using at least one applicable mathematical technique.

As noted above in connection with FIG. 1, and with FIGS. 2A, 2B, the signal source 106 and the detector 110 may be provided and configured in a variety of different embodiments and configurations. However, due to the fact that the source 106 and the detector 110 connect separately to different SM fiber components of the waveguide 202, there may be an advantage to providing them as separate components as a matter of design choice, without departing from the spirit of the invention.

Referring now to FIG. 4, a third embodiment of a distributed optical fiber detection system is shown as a distributed optical fiber detection system 200. The detection system 200 has much in common, in its construction and configuration, with the inventive detection system 10 of FIG. 1, with a waveguide 202, and its ends 204a, 204b being substantially similar to the waveguide 12 and its ends 14a, 14b, the signal source 206 being substantially similar to the signal source, a first signal 214a in a first mode being similar to the first signal 24a, where the waveguide 202 also comprises a sensitive region along the length L1, substantially similar to the sensitive region of the waveguide 12, wherein a perturbation 212 occurring in the waveguide 202 sensitive region, causes the waveguide 202 to couple at least a portion of the energy of the first signal mode of the signal 214a into a second signal mode (for example, that is of a different propagation constant from the first signal mode of the signal 214a, and that may, by way of example, be propagating at a velocity V₂), to produce a second signal 216a, while the remaining energy of the signal 214a in the first signal mode, continues in a modified signal 214b toward the second waveguide end 204b.

However, unlike the detection system 10, instead of a reflecting element 18 being positioned at the second end 14b of the waveguide 12 of FIG. 1, the detection system 200 comprises a detector 208 (that may be substantially similar to the detector 20 of FIG. 1), connected to the second end 204b of the waveguide 202, that is preferably capable of detecting at least one characteristic of the second signal 216a in the second signal mode that preferably enables the detector 208 to determine the occurrence of the perturbation 212 (and thus detect the occurrence of the event responsible for the perturbation 212), as well as to determine the distance L2 of the perturbation 212 from the first waveguide end 204a, using at least one applicable mathematical technique (using a different expression than the expressions that may be utilized by the detectors of FIGS. 1, 2A, 2B, 3, 5 and 6).

Referring now to FIG. 5, a first alternate embodiment of the distributed optical fiber detection systems 10 and 100, of FIGS. 1 and 3, respectively, is shown as a distributed optical fiber detection system 300. The detection system 300 is configured similarly to, and preferably operates in a similar principal manner as the inventive optical fiber detection systems 10 and 100, of FIGS. 1 and 3, except that the detection system 300 comprises a waveguide 302 of a length L1A, which includes multiple sensitive regions 306a to 306c with non-sensitive waveguide regions 304a to 304d being positioned at each waveguide 302 end, and also being positioned between each of the sensitive regions 306a to 306c thereof. It should be noted that three sensitive regions 306a, 306b, and 306c, and four corresponding non-sensitive regions 304a to 304d, and the individual and relative sizes of each, bare shown by way of example only—as many sensitive and non-sensitive regions as are desired and/or as may be practical, may certainly be utilized as a matter of design choice without departing from the spirit of the invention. By way of example, multiple perturbations 314a, and 314b occurring at different sensitive regions 306a and 306c, along the length L1A of the waveguide 302, may be readily detected, and their distances L2B, and L2C, respectively, relative to a first end of the waveguide 302, may be likewise determined by a detector 320.

Referring now to FIG. 6, a second alternate embodiment of the distributed optical fiber detection systems 10 and 100 of FIGS. 1 and 3, respectively, is shown as a distributed optical fiber detection system 400 that is, by way of example, in an exemplary “field” utilization thereof. The detection system 400 may be provided for use with a resource transportation pipeline 402 (or equivalent) of a length L4, in order to detect resource leaks therefrom, breaches thereof, other damage thereto, proximately occurring fires, explosions, or rather drastic changes in proximal temperature. The detection system 400 includes an elongated waveguide 406 with a plurality of sensitive regions along its length L1B, shown by way of example, as four sensitive regions 408a to 408d, with plural non-sensitive waveguide regions 412a to 412d positioned at along the waveguide 406, with at least one non-sensitive waveguide region being positioned between any two plural sensitive regions. The detection system 400 also includes a signal source/detector 416 (such as the signal source/detector 50 of FIG. 2A, which may also be implemented as two separate components) is preferably connected to the first end of the waveguide 406 either directly (not shown) or via a suitable connector 418 as shown, and also includes a reflection element 414 at a second end of the waveguide 406.

As was noted above, while certain perturbations may be inflicted, by occurrence of corresponding events, directly on at least one sensitive region 408a to 408d of the waveguide 406, the inventive detection system 400 preferably includes at least one additional perturbation component, proximal to, or in contact with, at least one sensitive region of the waveguide 406, that is capable of causing a perturbation in its corresponding proximal sensitive region of the waveguide 406 in response to occurrence of at least one predetermined proximal event, such as contact with a leaked resource or with another sensed material. By way of example, the sensitive regions 408d and 408d, are shown with such exemplary perturbation components 410c and 410d, positioned thereon, respectively.

Thus, as a n example, if a resource leak event 404b causes a quantity of the leaked resource from the pipeline 402 to come into contact with the perturbation component 410c, the perturbation component 410c, directly, or through an intervening proximal element, may expand or otherwise deform and thus cause pressure on a proximal sensitive waveguide region 408c, in response to contact with the petroleum, sufficient to cause a detectable perturbation 420b to occur at a distance L3B from the waveguide 406 first end.

Furthermore, in one alternate embodiment of the detection system 400, the waveguide 406 includes at least one sensitive region, positioned as a matter of design choice, that is provided and configured to be responsive to one or more different types of event(s) occurring proximal thereto, than the other sensitive regions, and that may thus include different types of perturbation components. For example, while the sensitive regions 408c and 408d include the above-described perturbation components 410c and 410d, the sensitive region 408a and 408b may include perturbation components 410a and 410b that are sensitive to rapid changes in temperature, so that, for example, a fire event 404a would cause a corresponding perturbation 420a in the sensitive region 408a, through the perturbation component 410a, at a distance L2B from the waveguide 406 first end.

Finally, it should also be noted that all of the advantageous exemplary embodiments of the inventive detection system described above in connection with FIGS. 1-6, may be readily utilized in conjunction with a previously known conventional TDR detection system that detects perturbations that are sufficient to disrupt its sensing portion, especially if a conventional OTDR is used as a signal source/detector. Moreover, the functions of a conventional TDR detection system may be readily implemented in the inventive detection system by configuring the detector to monitor for, and to detect, reflected signals in the first mode (i.e., the same mode as the initially launched signal). Thus, referring now to FIG. 1, the detector 20 may be configured to sense any reflection of the first mode signal 24a. Because the reflective element 18 does not reflect the first mode signal 24a, the presence of a reflected signal 24a at the detector 20 would indicate that a disruption of the waveguide 12 of sufficient magnitude to cause an internal reflection of the launched first mode signal 24a, had occurred. The detector 20 can then readily determine the location of such a disruption.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. An optical fiber detection system for detecting at least one event affecting at least one portion thereof, comprising:
a bi-directional optical fiber waveguide of a first length, having a first end and a second end, operable to guide a plurality of different electromagnetic signal modes between said first an said second ends, and further comprising at least one event-sensitive region positioned between said first and said second ends, such that when a first signal is launched into said waveguide first end in at least one first plural signal mode, and at least one event affects at least a portion of said at least one event-sensitive region, said bi-directional waveguide couples at least a first portion of said at least one first plural signal mode into at least one second plural signal mode of a different propagation constant from said at least one first signal mode, to produce a second signal;
a signal source, operable to launch, into said waveguide first end, said first signal in said at least one first plural signal mode;
a reflection element, positioned proximal to said waveguide second end, operable to reflect at least a portion of said second signal in said at least one second plural mode, to produce a reflected signal having at least one detectable characteristic, toward said waveguide first end; and
a detector, operable to:
receive said reflected signal from said waveguide first end; and
determine, based on said at least one reflected signal characteristic, at least one of: a quantity of at least one event, and at least one position of each of the at least one event along said first length of said waveguide.

2. The optical fiber detection system of claim 1, wherein the at least one event affects said at least one event-sensitive region by causing at least one perturbation thereof.

3. The optical fiber detection system of claim 1, wherein said waveguide comprises a multi-mode optical fiber.

4. The optical fiber detection system of claim 1, wherein said waveguide comprises a polarization maintaining optical fiber.

5. The optical fiber detection system of claim 4, wherein said at least one first plural signal mode comprises a first polarization signal mode, and wherein said at least one second plural signal mode comprises a second polarization signal mode.

6. The optical fiber detection system of claim 5, wherein said reflection element comprises:
a polarizer, operable to only pass said second polarization signal mode therethrough; and
a mirror element, operable to reflect said second polarization signal mode passed by said polarizer.

7. The optical fiber detection system of claim 6, wherein said polarizer comprises an in-line chiral fiber polarizer.

8. The optical fiber detection system of claim 5, wherein said detector is operable to only detect said second signal in said second polarization signal mode.

9. The optical fiber detection system of claim 1, wherein said at least one first plural signal mode comprises a first signal mode, and wherein said at least one second plural signal mode comprises a second signal mode, and wherein said waveguide comprises a first single mode fiber configured for guiding said first signal mode therethrough, and a second single mode fiber configured for guiding said second signal mode therethrough.

10. The optical fiber detection system of claim 9, wherein said first single mode fiber comprises a first numerical aperture, and wherein said second single mode fiber comprises a second numerical aperture that is different from said first numerical aperture.

11. The optical fiber detection system of claim 1, wherein said at least one characteristic comprises at least one of: an amplitude of, a phase shift of, or a time delay of said reflected signal.

12. The optical fiber detection system of claim 1, wherein said at least one event comprises at least one of:
a change in temperature proximal to said at least one event-sensitive region outside a predefined temperature range;
a predetermined amount of pressure exerted on said at least one event-sensitive region; and
a presence of at least one first predetermined material proximal to said at least one event-sensitive region.

13. The optical fiber detection system of claim 5, wherein said at least one event-sensitive region comprises:
at least one pressure transducer operable to transfer and apply pressure from at least one pressure source to said polarization maintaining optical fiber, such that at least a portion of said first polarization signal mode is coupled into said second polarization signal mode; and
at least one elongated sensing element in contact with said at least one pressure transducer, operable, when exposed to at least one predetermined sensed material in at least a predefined quantity, to expand and to thereby apply pressure on said at least one pressure transducer sufficient to cause pressure on said polarization maintaining optical fiber through said at least one pressure transducer.

14. The optical fiber detection system of claim 5, wherein said at least one event-sensitive region comprises:
at least one temperature transducer operable to apply, in response to a change in temperature thereof outside a predetermined range, pressure to said polarization maintaining optical fiber sufficient to cause at least a portion of said first polarization signal mode to be coupled into said second polarization signal mode.

15. The optical fiber detection system of claim 9, wherein said at least one event-sensitive region comprises:
a first unjacketed single mode fiber configured for guiding said first signal mode therethrough having a first diameter, and a second unjacketed single mode fiber configured for guiding said second signal mode therethrough having a second diameter, wherein said first and second diameters are sufficiently small to cause at least a portion of said first signal mode to be coupled into said second signal mode when said unjacketed first and second fibers are exposed to at least one predetermined sensed material.

16. The optical fiber detection system of claim 9, wherein said reflecting element comprises a mirror positioned at said second end of said second single mode fiber.

17. The optical fiber detection system of claim 1, wherein said signal source and said detector comprise a single device.

18. The optical fiber detection system of claim 17, wherein said single device is an optical time domain reflectometer.

19. The optical fiber detection system of claim 1, wherein when said at least one event causes a disruption in said waveguide sufficient to cause said waveguide to reflect at least a portion of said first signal in said at least one first plural mode, said detector is further operable to detect the presence of said reflected first plural mode signal, and to determine a position of said disruption along said first length of said waveguide

20. The optical fiber detection system of claim 2, wherein when said waveguide is positioned proximal to and along at least a portion of a length of a pipeline transporting a predetermined resource, and wherein said at least one event comprises at least one of: a leak of said predetermined resource from said pipeline proximal to said at least one event-sensitive region of said waveguide, and a rapid increase in temperature proximal to said at least one event-sensitive region of said waveguide, that exceeds a predefined temperature gradient value.

21. The optical fiber detection system of claim 20, wherein when said resource is at least one of: at least one type of petroleum, natural gas, at least one liquid or gaseous natural or chemical product.

22. An optical fiber leak detection system for use with a pipeline of a predetermined length that transports a resource, the leak detection system being operable to detect a presence of, and a position of along the predetermined length, of at least one leak of the transported resource comprising:
a bi-directional waveguide of a first length, having a first end and a second end, operable to guide two different electromagnetic signal modes between said first and said second ends, and further comprising at least one leak-sensitive region positioned between said first and said second ends;
at least one perturbation element, positioned proximal to the pipeline and to said at least one leak-sensitive waveguide region, operable to cause a perturbation in said at least one leak-sensitive region in response to occurrence of the at least one resource leak proximal thereto, such that when a first signal in a first signal mode is launched into said waveguide first end, and at least one resource leak occurs in at least a portion of said at least one event-sensitive region, said at least one perturbation element causes said waveguide to couple at least a first portion of said at least one first signal mode into a second signal mode to produce a mode-coupled signal;
a signal source, operable to launch, into said waveguide first end, said first signal in said first signal mode;
a reflection element, positioned at said waveguide second end, operable to reflect at least a portion of said mode-coupled signal in said second mode, to produce a reflected signal in said second mode, having at least one detectable characteristic, toward said waveguide first end; and
a detector, operable to:
receive said reflected signal from said waveguide first end; and
determine, based on said at least one reflected signal characteristic, at least one of: a quantity of the at least one leak, and at least one position of each of the at least one leak along said waveguide length.

23. An optical fiber detection system for detecting at least one event affecting at least one portion thereof, comprising:
a bi-directional waveguide of a first length, having a first end and a second end, operable to guide two different electromagnetic signal modes between said first and said second ends, and further comprising at least one event-sensitive region positioned between said first and said second ends, such that when a first signal in a first signal mode is launched into said waveguide first end, and at least one event affects at least a portion of said at least one event-sensitive region, said bi-directional waveguide couples at least a first portion of said at least one first signal mode into a second signal mode to produce a mode-coupled signal having at least one characteristic;
a signal source, operable to launch, into said wave guide first end, said first signal in said at first signal mode;
a detector, operable to:
receive said mode-coupled signal from said waveguide second end, and
determine, based on said at least one mode-coupled signal characteristic, at least one of: a quantity of at least one event, and at least one position of each of the at least one event along said waveguide length.
